(19) United States
(12) Patent Application Publication
(10) Pub. No.: US 2005/0259965 A1
(43) Pub. Date: Nov. 24, 2005

(54) Video recording/reproduction method

(75) Inventor: Tsukuru Ishito, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/119,468

(22) Filed: May 2, 2005

(30) Foreign Application Priority Data
May 19, 2004 (JP) 2004-148739

(51) Int. Cl. H04N 5/76; G11B 15/04; G11B 19/04

(52) U.S. Cl. 386/94; 360/60; 380/201

(57) ABSTRACT

Content (A) recorder who recorded content (A) on a hard disk sets content (A) reproduction-permitted registrant who is permitted to reproduce content (A). With such a feature, reproduction management of content (A) is realized in a more detailed manner.

### CROSS-REFERENCE TO RELATED APPLICATION

This nonprovisional application claims priority under 35 U.S.C. §119(a) on Japanese Patent Application No. 2004-148739 filed on May 19, 2004, and the entire contents disclosed in the claims, specification and drawings of this application are hereby incorporated by reference.

### BACKGROUND OF THE INVENTION

The present invention relates to a video recording/reproduction method employed when a plurality of users share a video recording/reproduction device.

Japanese Unexamined Patent Publication No. 2001-326898 discloses a conventional video recording/reproduction device wherein a content recorded by each of a plurality of users is not available to the other users for display, falsification or deletion. A web page on the Internet of Sony Corporation introducing Digital Recorder NDR-XR1 discloses a recorder wherein recorded contents are sorted into folders.

Further, recorders having various functions have been developed. Japanese Unexamined Patent Publication No. 2002-344879 discloses a recorder wherein when an empty capacity of a hard disk is equal to or smaller than a predetermined capacity, the recorded data are automatically erased in order of oldness (from the oldest item) to secure an empty space for a new recording. Japanese Unexamined Patent Publication No. 2002-314911 discloses a recorder wherein the storage status of recorded video information can be modified by a user.

FIG. 11 is a block diagram of a conventional video recording/reproduction device. In FIG. 11, reference numeral 301 denotes an instruction input section, reference numeral 302 denotes a video input section, reference numeral 303 denotes an encoder, reference numeral 304 denotes a control section, reference numeral 305 denotes a decoder, reference numeral 306 denotes a video output section, reference numeral 307 denotes a storage section, reference numeral 308 denotes user ID, reference numeral 309 denotes a nonvolatile storage section, reference numeral 310 denotes registrant (1) ID, reference numeral 311 denotes registrant (1) authentication information, reference numeral 312 denotes registrant (1) usable capacity, reference numeral 313 denotes registrant (1) cryptographic key information, reference numeral 314 denotes registrant (2) ID, reference numeral 315 denotes registrant (2) authentication information, reference numeral 316 denotes registrant (2) usable capacity, reference numeral 317 denotes registrant (2) cryptographic key information, reference numeral 318 denotes registrant (N) ID, reference numeral 319 denotes registrant (N) authentication information, reference numeral 320 denotes registrant (N) usable capacity, reference numeral 321 denotes registrant (N) cryptographic key information, reference numeral 322 denotes registrant (1) used space, reference numeral 323 denotes registrant (2) used space, reference numeral 324 denotes registrant (N) used space, reference numeral 325 denotes a hard disk, reference numeral 326 denotes content (A), reference numeral 327 denotes content (B), reference numeral 328 denotes content (N), reference numeral 329 denotes an optical disc.

The control section 304 controls the instruction input section 301, the video input section 302, the encoder 303, the decoder 305, the video output section 306, the storage section 307, the nonvolatile storage section 309, the hard disk 325 and the optical disc 329 according to a program stored in the nonvolatile storage section 309.

In the video recording process of the video recording/reproduction device, an analog video signal input from an external device through the video input section 302 is converted by the encoder 303 to a digital video signal of MPEG2 format, and the digital video signal is stored as a content in the hard disk 325.

In the video reproduction process, the content which is stored in the hard disk 325 in the form of the digital video signal of MPEG2 format is converted by the decoder 305 to an analog video signal. The analog video signal is output to an external device through the video output section 306.

In the video dubbing process, the content stored in the hard disk 325 is copied or moved onto the optical disc 329.

Various data setting processes are carried out using a remote controller, wherein the user ID 308 input through the instruction input section 301 is stored in the storage section 307, and the registrant (1) ID 310, the registrant (1) authentication information 311, the registrant (1) usable capacity 312, the registrant (2) ID 314, the registrant (2) authentication information 315, the registrant (2) usable capacity 316, the registrant (N) ID 318, the registrant (N) authentication information 319 and the registrant (N) usable capacity 320 are stored in the nonvolatile storage section 309.

An operation of the video recording/reproduction device having the above-described structure is described based on the flowchart shown in FIG. 12.

Referring to FIG. 12, at step S401 after the power on, the user selects whether or not he/she determines initial settings. If the user determines initial settings (“YES” at step S401), the process branches to step S402. At step S402, registrant ID for specifying a person who is permitted to use the device, registrant authentication information used for authenticating the registrant, and the registrant usable capacity which determines the capacity available to the user, which are input through the remote controller, are stored.

If the user does not determine initial settings (“NO” at step S401), the process branches to step S404, and the device enters the user authentication queue state.

At step S403, cryptographic key information associated with each registrant ID is calculated, and the calculated cryptographic key information is stored as registrant cryptographic key information. At step S404, a user who inputs his/her own information (user ID, user authentication information) with the remote controller is authenticated. If the user is not authenticated as a registrant, the device again enters the user authentication queue state.

If the user is authenticated as a registrant at step S404, it is determined at step S405 whether or not the recording mode processing is performed. If “YES” at step S405, the process branches to step S410 of FIG. 14. If “NO” at step S405, the process branches to step S406.

At step S406, it is determined whether or not the reproducible content list display mode processing is performed. If “YES” at step S406, the process branches to step S415 of FIG. 15. If “NO” at step S406, the process branches to step S407.

At step S407, it is determined whether or not the reproduction mode processing is performed. If “YES” at step S407, the process branches to step S416 of FIG. 16. If “NO” at step S407, the process branches to step S408 of FIG. 13. At step S408, it is determined whether or not the key entry has been performed.

If “YES” at step S408, the key entry processing is performed. If “NO” at step S408, other processing is performed. Lastly, at step S409, it is determined whether or not the remote control entry has been performed.

If “YES” at step S409, the remote control entry processing is performed. If “NO” at step S409, the process returns to step S404, and the device enters the user authentication queue state.

FIG. 14 is a flowchart showing the recording mode processing operation of the video recording reproduction device. In FIG. 14, at step S410, it is determined whether or not the remaining capacity is equal to or smaller than a threshold value. If it is determined at step S410 that the remaining capacity is equal to or smaller than the threshold value, the recording mode is canceled. The process returns to step S404, and the device enters the user authentication queue state.

If it is determined at step S410 that the remaining capacity of the hard disk is not equal to or smaller than the threshold value, the process branches to step S411. At step S411, the recording processing is performed while a content is encrypted using the registrant cryptographic key information associated with the user.

At step S412, the remaining capacity of the hard disk is monitored during the recording. If there is a sufficient empty space, the process branches to step S413. If the remaining capacity of the hard disk has been exhausted, the process branches to step S414, and the recording is terminated.

At step S413, it is determined whether or not a recording termination factor, such as a key entry, a remote control entry, arrival of the end time of timer recording, or the like, has occurred. If “YES” at step S413, the process branches to step S414, and the recording is terminated. Then, the process returns to step S404, and the device enters the user authentication queue state. If “NO” at step S413, the process branches to step S411, and the recording processing is performed again.

FIG. 15 is a flowchart showing the reproducible content list display mode processing operation. In FIG. 15, at step S415, the recording date of contents, the content name and the recording mode, which are associated with all of the accumulated contents, are displayed in the form of a list. Then, the process returns to step S404, and the device enters the user authentication queue state.

FIG. 16 is a flowchart showing the reproduction mode processing operation. In FIG. 16, at step S416, the reproduction processing is performed. Then at step S417, it is determined whether or not a recording termination factor, such as a key entry, a remote control entry, or the like, has occurred. If “NO” at step S417, the process branches to step S416, and the reproduction process is performed again.

If “YES” at step S417, the process branches to step S418, the reproduction is ended. Then, the process returns to step S404, and the device enters the user authentication queue state.

However, in the conventional video recording/reproduction method, a user is authenticated by data entry with a remote controller, and therefore, the authentication process takes time and effort.

Reproduction of video information recorded by a user only has two options. That is, only the user who recorded the video information is permitted to reproduce the video information, or all of the registered users are permitted to reproduce the video information. For example, the reproduction setting cannot be set such that only 5 out of 10 users are permitted to reproduce the video information.

Further, a content recorded by a user is recorded in a region of a recording medium which is allocated to the user who recorded the content. Even if all the registered users are permitted to reproduce the content, the content is recorded only in the region allocated to the user who recorded the content without using any of the recording medium regions allocated to the other users. Thus, a sense of partiality arises between the user who recorded the content and the other users.

When the recording medium is full of contents, the contents are automatically erased in order of oldness (from the oldest item) regardless of whether or not the contents are actually reproduced by users who are permitted to reproduce the contents.

### SUMMARY OF THE INVENTION

The present invention was conceived in view of the above problems. An objective of the present invention is to provide a video recording/reproduction method which improves the convenience of a user in recording/reproduction of video contents.

According to the present invention, there is provided a video recording/reproduction method, comprising the steps of: connecting a detachable storage medium which stores a user ID indicative of a user who uses a video recording/reproduction device for recording/reproducing video data and user authentication information used for authenticating the user to the video recording/reproduction device; collating the user ID with a registrant ID indicative of a registrant who is registered in advance in the video recording/reproduction device and permitted to use the video recording/reproduction device and collating the user authentication information with registrant authentication information which is registered in advance in the video recording/reproduction device and used for authenticating the registrant; if the user ID matches the registrant ID and the user authentication information matches the registrant authentication information at the collation step, permitting the user to use the video recording/reproduction device; and if a result of the collation indicates no match, prohibiting the user to use the video recording/reproduction device.

According to the present invention, the video recording/reproduction method may further comprise the steps of: setting the user ID as a content reproduction-permitted registrant ID indicative of a registrant who is permitted to reproduce the content in association with a content recorded by the user; selecting the content the user is permitted to reproduce; displaying a reproducible content list including at least a recording date, content name and recording mode which are associated with the content; selecting the content recorded by the user from the displayed reproducible content list; setting another registrant as a content reproduction-permitted registrant of the selected content; and deleting the user ID from among the content reproduction-permitted registrant IDs associated with the content the user is permitted to reproduce.

According to the present invention, the video recording/reproduction method may further comprise the steps of: equally dividing the amount of the content by the number of the content reproduction-permitted registrants; and assigning the equally-divided content amount to a registrant use capacity indicative of the capacity of a recording medium the registrant who is set as the content reproduction-permitted registrant can use.

According to the present invention, the video recording/reproduction method may further comprise the steps of: setting content reproduction history information that shows which part of a region storing the content has been reproduced by the content reproduction-permitted registrant; and displaying the content reproduction history information such that the content reproduction history information is included in the reproducible content list.

According to the present invention, the video recording/reproduction method may further comprise the steps of: if the remaining capacity of the recording medium is equal to or smaller than a threshold value, extracting a content which has already been reproduced by all of the content reproduction-permitted registrants from the content reproduction history information; and deleting the extracted content.

According to the present invention, the video recording/reproduction method may further comprise the steps of: if the remaining capacity of the recording medium is equal to or smaller than a threshold value, extracting a content which has already been reproduced by all of the content reproduction-permitted registrants from the content reproduction history information; and moving the extracted content to another recording medium.

As described above, according to the video recording/reproduction method of the present invention, a removable recording medium which stores a user ID and user authentication information, such as an SD card, for example, can be used. Thus, user authentication is realized with improved convenience.

According to the present invention, a content reproduction-permitted registrant can be set for a recorded content. Thus, reproduction management of contents is realized in a more detailed manner.

According to the present invention, the amount of a content to be recorded is equally divided by the number of content reproduction-permitted registrants. Thus, balanced recording medium use management is possible.

When the remaining capacity of a recording medium is equal to or smaller than a threshold value, the content reproduction history information is automatically referred to erase a content which has already been reproduced by all of the content reproduction-permitted registrants or move the content to an optical disc connected to the video recording/reproduction device. Thus, recording medium use management is realized with improved convenience.

### BRIEF DESCRIPTION OF THE DRAWINGS

FIG. 1 is a block diagram of a video recording/reproduction device according to an embodiment of the present invention.

FIG. 2 is a flowchart illustrating an operation of a principal part of a video recording/reproduction device according to an embodiment of the present invention.

FIG. 3 is a flowchart illustrating an operation of a part of a video recording/reproduction device according to an embodiment of the present invention.

FIG. 4 is a flowchart illustrating the recording mode processing of a video recording/reproduction device according to an embodiment of the present invention.

FIG. 5 is a flowchart illustrating the reproducible content list display mode processing of a video recording/reproduction device according to an embodiment of the present invention.

FIG. 6 is a flowchart illustrating the reproducible content list display mode processing of a video recording/reproduction device according to an embodiment of the present invention.

FIG. 7 is a flowchart illustrating the reproduction mode processing of a video recording/reproduction device according to an embodiment of the present invention.

FIG. 8 is a flowchart illustrating a process performed by a video recording/reproduction device according to an embodiment of the present invention when the remaining capacity is equal to or smaller than a threshold value.

FIG. 9 is a flowchart illustrating a process performed by a video recording/reproduction device according to an embodiment of the present invention when the remaining capacity is equal to or smaller than a threshold value.

FIG. 10 is a flowchart illustrating the procedure of user authentication by SD card input in a video recording/reproduction device according to an embodiment of the present invention.

FIG. 11 is a block diagram of a conventional video recording/reproduction device.

FIG. 12 is a principal part of a flowchart which illustrates an operation of a conventional video recording/reproduction device.

FIG. 13 is a flowchart which illustrates the key entry and remote control entry processing of a conventional video recording/reproduction device.

FIG. 14 is a flowchart which illustrates the recording mode processing of a conventional video recording/reproduction device.

FIG. 15 is a flowchart illustrating the reproducible content list display mode processing of a conventional video recording/reproduction device.

FIG. 16 is a flowchart illustrating the reproduction mode processing of a conventional video recording/reproduction device.

### DESCRIPTION OF THE PREFERRED EMBODIMENTS

Hereinafter, an embodiment of the present invention is described in detail with reference to the drawings. The preferred examples described below are merely exemplary in essence and do not intend to limit the present invention, applications or uses thereof.

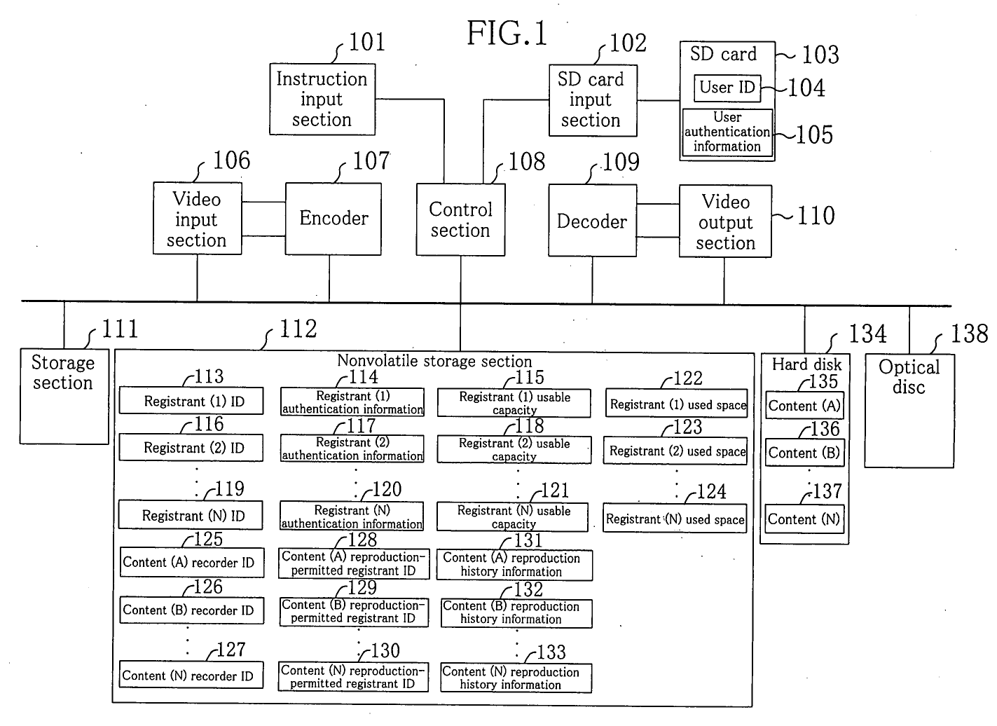

FIG. 1 is a block diagram of a video recording/reproduction device according to an embodiment of the present invention. In FIG. 1, reference numeral 101 denotes an instruction input section, reference numeral 102 denotes an SD card input section, reference numeral 103 denotes an SD card, reference numeral 104 denotes user ID, reference numeral 105 denotes user authentication information, reference numeral 106 denotes a video input section, reference numeral 107 denotes an encoder, reference numeral 108 denotes a control section, reference numeral 109 denotes a decoder, reference numeral 110 denotes a video output section, reference numeral 111 denotes a storage section, reference numeral 112 denotes a nonvolatile storage section, reference numeral 113 denotes registrant (1) ID, reference numeral 114 denotes registrant (1) authentication information, reference numeral 115 denotes registrant (1) usable capacity, reference numeral 116 denotes registrant (2) ID, reference numeral 117 denotes registrant (2) authentication information, reference numeral 118 denotes registrant (2) usable capacity, reference numeral 119 denotes registrant (N) ID, reference numeral 120 denotes registrant (N) authentication information, reference numeral 121 denotes registrant (N) usable capacity, reference numeral 122 denotes registrant (1) used space, reference numeral 123 denotes registrant (2) used space, reference numeral 124 denotes registrant (N) used space, reference numeral 125 denotes content (A) recorder ID, reference numeral 126 denotes content (B) recorder ID, reference numeral 127 denotes content (N) recorder ID, reference numeral 128 denotes content (A) reproduction-permitted registrant ID, reference numeral 129 denotes content (B) reproduction-permitted registrant ID, reference numeral 130 denotes content (N) reproduction-permitted registrant ID, reference numeral 131 denotes content (A) reproduction history information, reference numeral 132 denotes content (B) reproduction history information, reference numeral 133 denotes content (N) reproduction history information, reference numeral 134 denotes a hard disk, reference numeral 135 denotes content (A), reference numeral 136 denotes content (B), reference numeral 137 denotes content (N), and reference numeral 138 denotes an optical disc.

The control section 108 controls the instruction input section 101, the SD card input section 102, the video input section 106, the encoder 107, the decoder 109, the video output section 110, the storage section 111, the nonvolatile storage section 112, the hard disk 134 and the optical disc 138 according to a program stored in the nonvolatile storage section 112.

In the video recording process of the video recording/reproduction device, an analog video signal input from an external device through the video input section 106 is converted by the encoder 107 to a digital video signal of MPEG2 format, and the digital video signal is stored as a content in the hard disk 134.

In the video reproduction process, the content which is stored in the hard disk 134 in the form of the digital video signal of MPEG2 format is converted by the decoder 109 to an analog video signal. The analog video signal is output to an external device through the video output section 110.

In the video dubbing process, the content stored in the hard disk 134 is copied or moved onto the optical disc 138.

Various data setting processes are carried out using a remote controller, wherein the registrant (1) ID 113, the registrant (1) authentication information 114, the registrant (1) usable capacity 115, the registrant (2) ID 116, the registrant (2) authentication information 117, the registrant (2) usable capacity 118, the registrant (N) ID 119, the registrant (N) authentication information 120, the registrant (N) usable capacity 121, the content (A) reproduction-permitted registrant ID 128, the content (B) reproduction-permitted registrant ID 129 and the content (N) reproduction-permitted registrant ID 130, which are input through the instruction input section 101, are stored in the nonvolatile storage section 112.

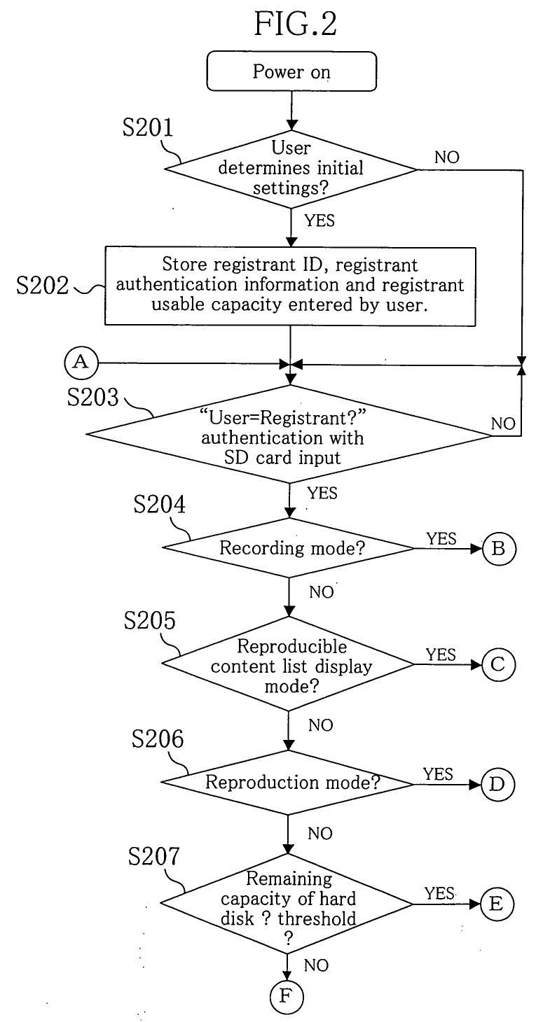

An operation of the video recording/reproduction device having the above-described structure is described based on the flowchart shown in FIG. 2.

Referring to FIG. 2, at step S201 after the power on, the user selects whether or not he/she determines initial settings. If the user determines initial settings (“YES” at step S201), the process branches to step S202. At step S202, a user uses a remote controller to enter registrant ID for specifying a person who is permitted to use the device, registrant authentication information used for authenticating the registrant, and the registrant usable capacity which determines the capacity available to the user in the nonvolatile storage section 112. Then, the process proceeds to step S203.

If the user does not determine initial settings (“NO” at step S201), the process branches to step S203, and the device enters the user authentication queue state for authentication with SD card input.

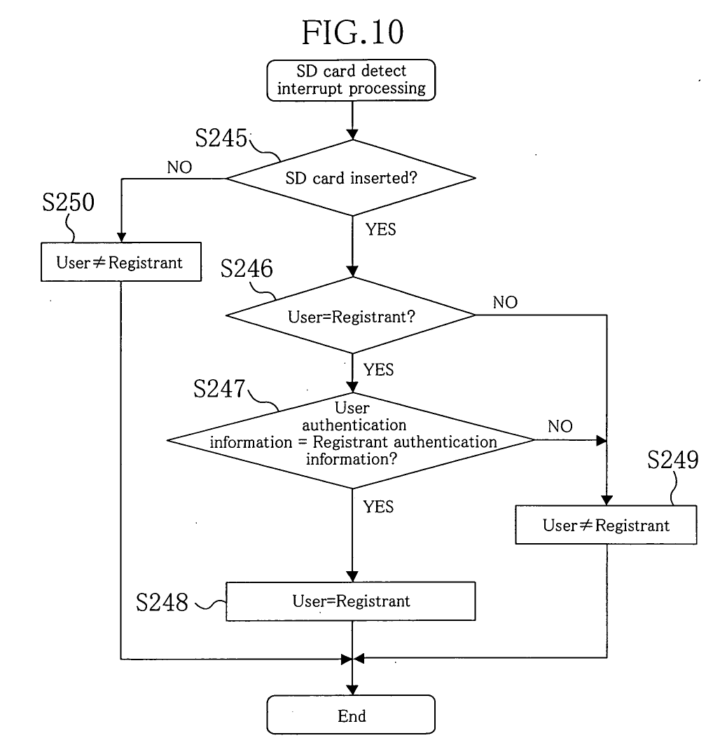

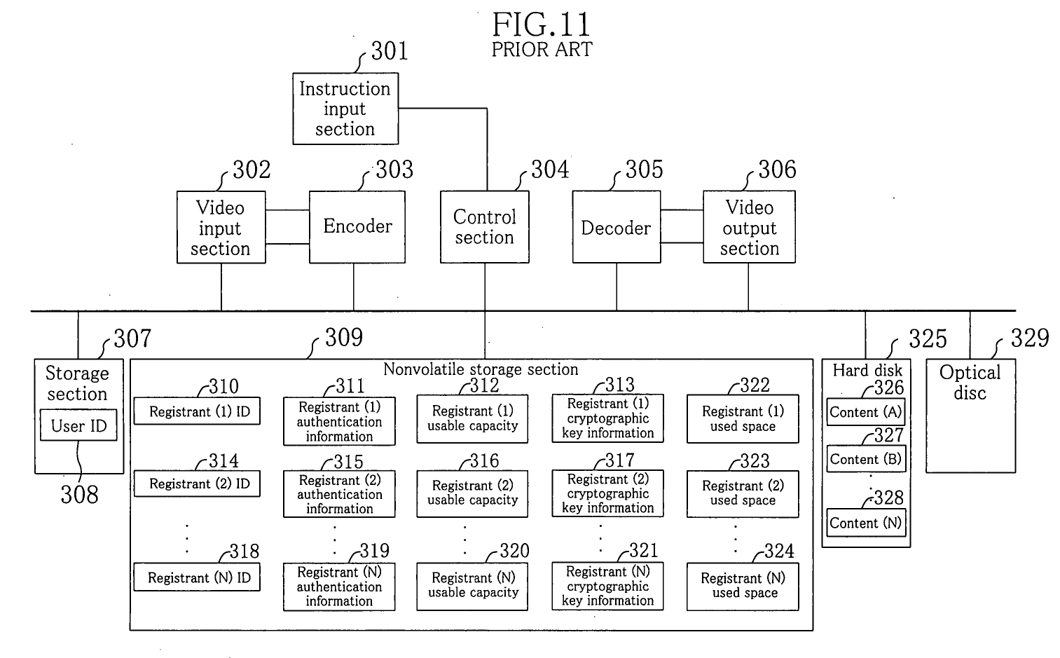

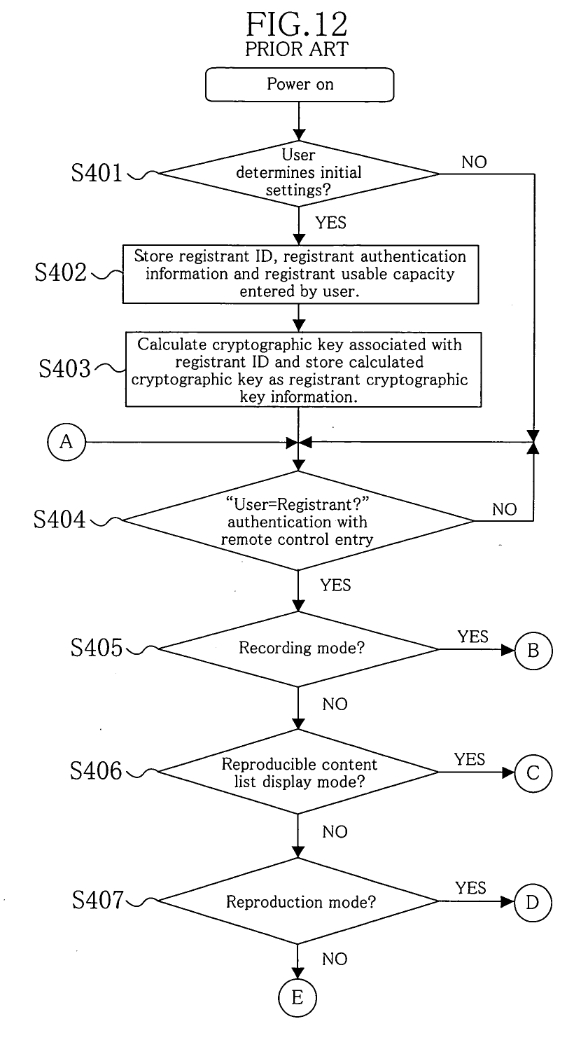

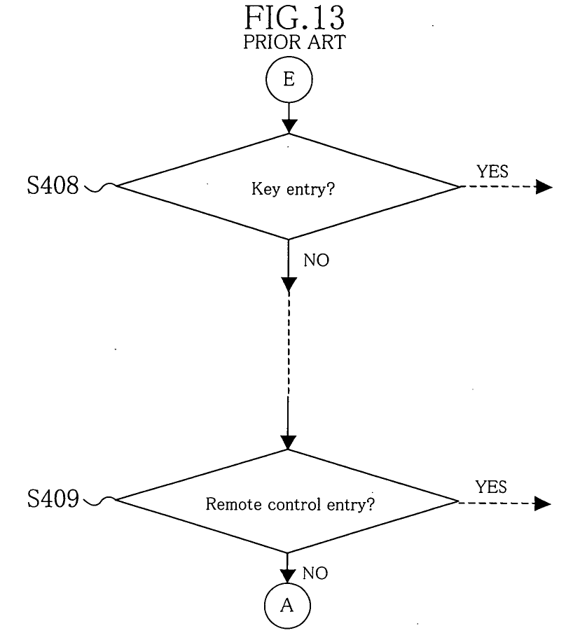

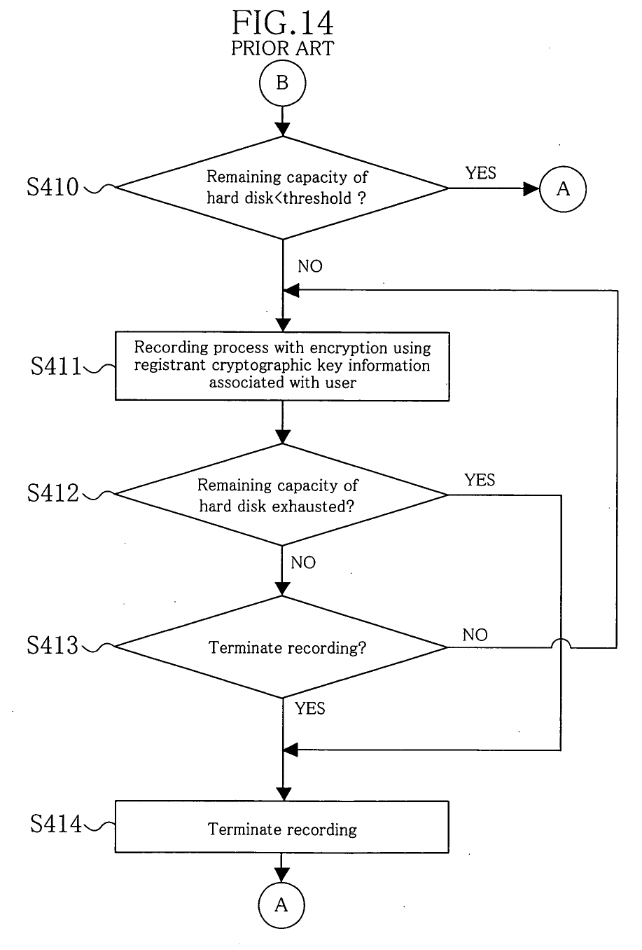

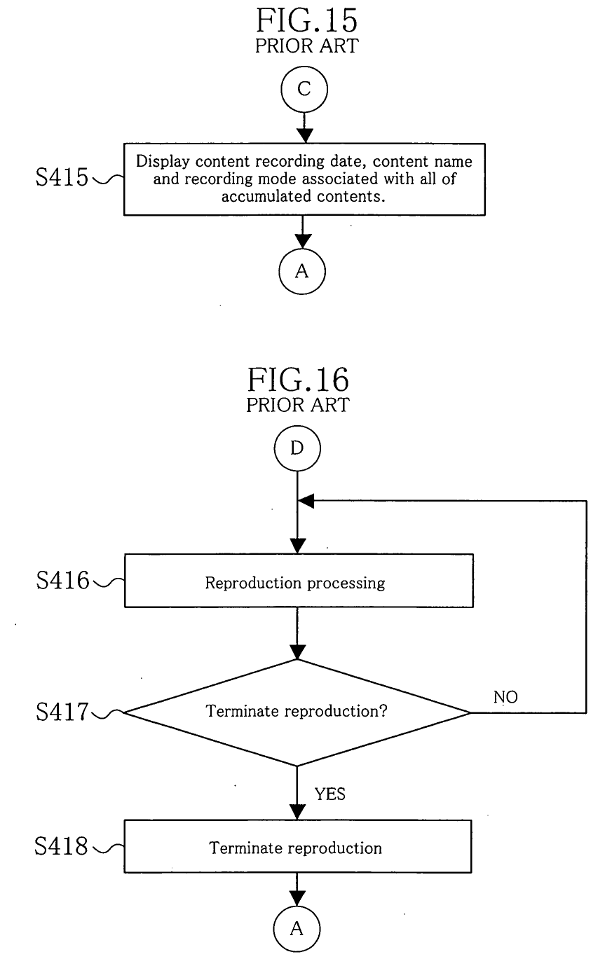

FIG. 10 is a flowchart illustrating the procedure of user authentication by SD card input. In FIG. 10, at step S245, it is determined whether or not a user has inserted in the video recording/reproduction device an SD card in which information about the user (user ID, user authentication information) are recorded. If “YES” at step S245, the process branches to step S246. If “NO” at step S245, it is determined that the SD card has been removed, and the process branches to step S250. At step S250, it is determined that the user is not a registrant, and the user authentication is then terminated.

At step S246, the user ID recorded in the SD card is collated with the registrant IDs stored in the device. If “YES” (match) at step S246, the process branches to step S247. If “NO” at step S246, the process branches to step S249. At step S249, it is determined that the user is not a registrant, and the user authentication is then terminated.

At step S247, the user authentication information is collated with the registrant authentication information. If “YES” (match) at step S247, the process branches to step S248. At step S248, it is determined that the user is a registrant, and the user authentication is then terminated. If “NO” at step S247, the process branches to step S249. At step S249, it is determined that the user is not a registrant, and the user authentication is then terminated.

Referring to FIG. 2, after the above-described user authentication, when a user inserts an SD card in the video recording/reproduction device, it is determined at step S203 whether or not the user is a registrant.

If “NO” at step S203, the device again enters the user authentication queue state for authentication with SD card input. If “YES” at step S203, it is determined at step S204 whether or not the recording mode process is performed.

If “YES” at step S204, the process branches to step S210. If “NO” at step S204, the process branches to step S205.

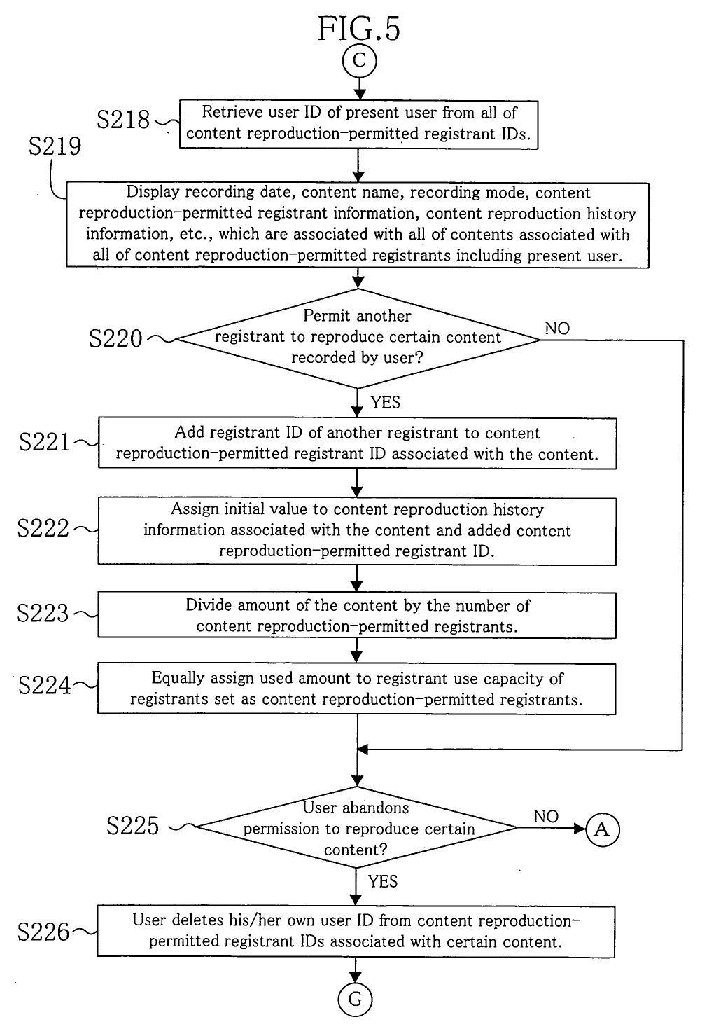

At step S205, it is determined whether or not the reproducible content list display mode processing is performed. If “YES” at step S205, the process branches to step S218 of FIG. 5. If “NO” at step S205, the process branches to step S206.

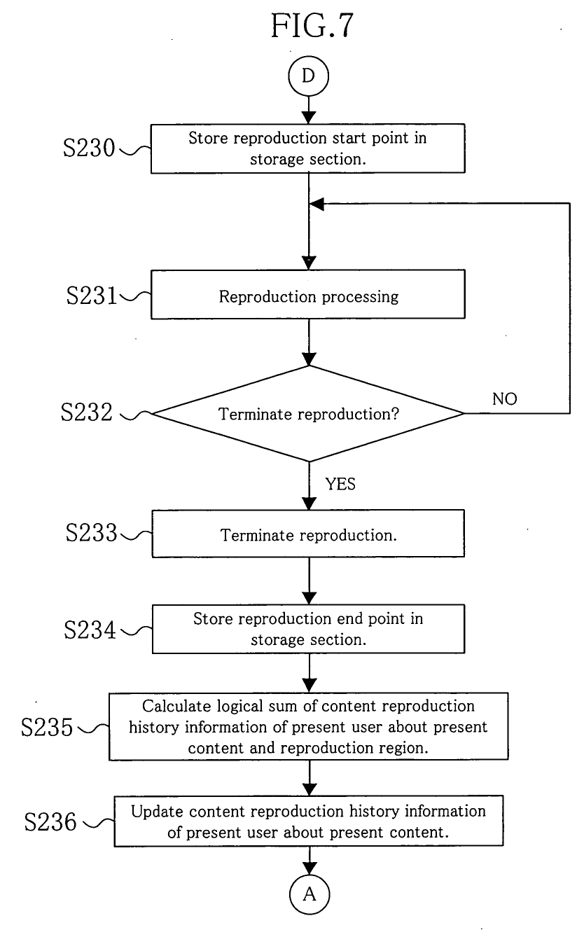

At step S206, it is determined whether or not the reproduction mode processing is performed. If “YES” at step S206, the process branches to step S230 of FIG. 7. If “NO” at step S206, the process branches to step S207.

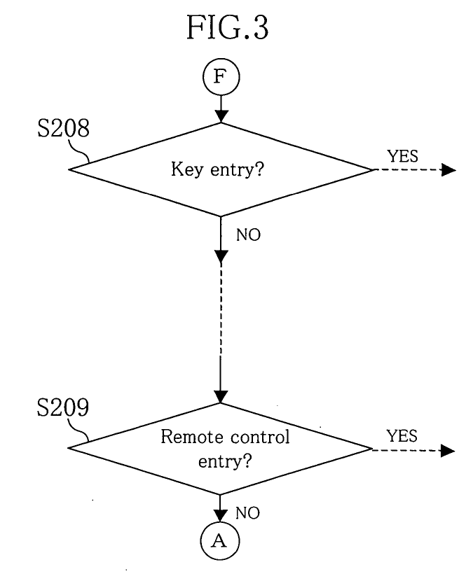

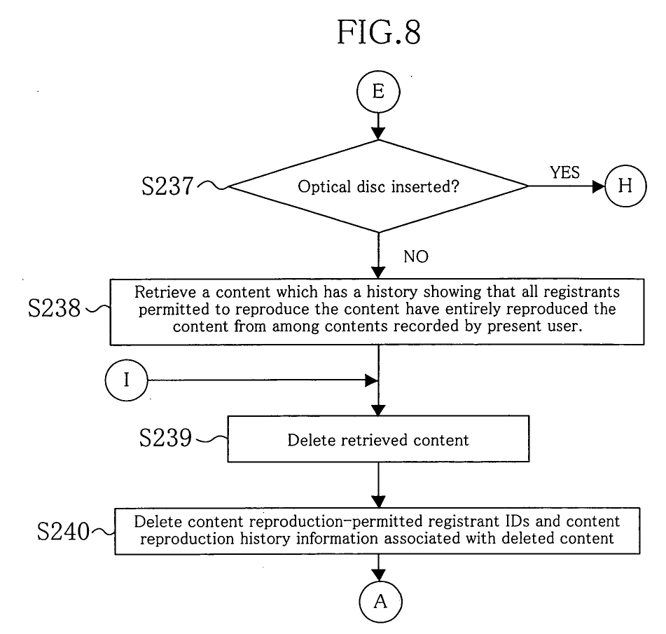

At step S207, it is determined whether or not the remaining capacity of the hard disk is equal to or smaller than the threshold value. If “YES” at step S207, the process branches to step S237 of FIG. 8. If “NO” at step S207, the process branches to step S208 of FIG. 3. At step S208, it is determined whether or not the key entry has been performed.

If “YES” at step S208, the key entry processing is performed. If “NO” at step S208, other processing is performed. Lastly, at step S209, it is determined whether or not the remote control entry has been performed.

If “YES” at step S209, the remote control entry processing is performed. If “NO” at step S209, the process returns to step S203, and the device enters the user authentication queue state for authentication with SD card input.

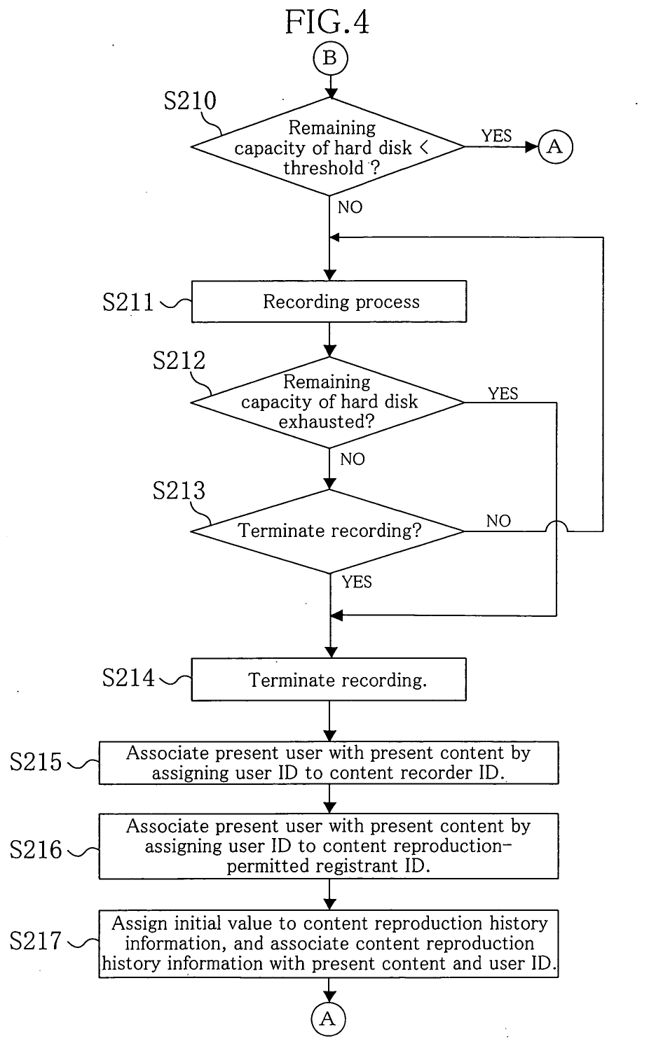

FIG. 4 is a flowchart showing the recording mode processing operation of the video recording reproduction device. In FIG. 4, at step S210, it is determined whether or not the remaining capacity of the hard disk is equal to or smaller than a threshold value. If it is determined at step S210 that the remaining capacity is equal to or smaller than the threshold value, the recording mode is canceled. The process returns to step S203, and the device enters the user authentication queue state.

If it is determined at step S210 that the remaining capacity of the hard disk is not equal to or smaller than the threshold value, the process branches to step S211, and the recording processing is performed. During the recording, the remaining capacity of the hard disk is monitored to determine whether or not the remaining capacity of the hard disk has been exhausted (S212).

If “YES” at step S212, the process branches to step S214, and the recording is terminated. If “NO” at step S212, the process branches to step S213. At step S213, it is determined whether or not a recording termination factor, such as a key entry, a remote control entry, arrival of the end time of timer recording, or the like, has occurred.

If “YES” at step S213, the process branches to step S214, and the recording is terminated. If “NO” at step S213, the process branches to step S211, and the recording processing is continued.

After the termination of the recording, at step S215, the present user is associated with the presently-recorded content by assigning the user ID of the present user to a content recorder ID which indicates a person who recorded the content, and information about this association is stored in the nonvolatile storage section 112.

At step S216, the present user is associated with the present content by assigning the user ID of the present user to the content reproduction-permitted registrant ID which indicates a registrant who is permitted to reproduce the content, and information about this association is stored in the nonvolatile storage section 112.

At step S217, an initial value is assigned to the content reproduction history information that shows which part of a region storing the content has been reproduced by the content reproduction-permitted registrant, and the content reproduction history information is associated with the present content and the user ID of the present user and stored in the nonvolatile storage section 112. Then, the process returns to step S203, and the device enters the user authentication queue state.

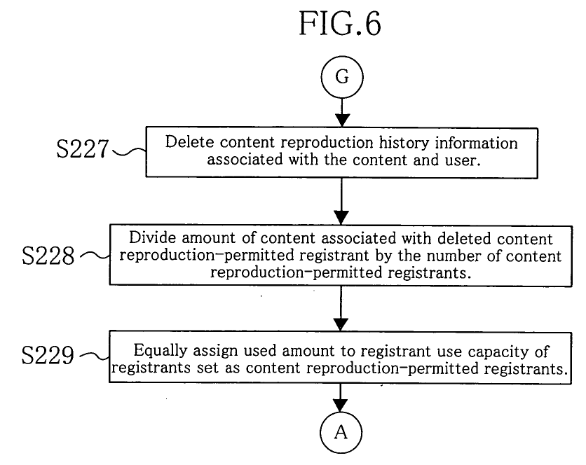

FIGS. 5 and 6 show a flowchart illustrating the reproducible content list display mode processing operation. In FIG. 5, at step S218, the user ID of the present user is retrieved from all of the content reproduction-permitted registrant IDs which are associated with all of the accumulated contents.

At step S219, the recording date, the content name, the recording mode, the content reproduction-permitted registrant IDs, the content reproduction history information, etc., which are associated with all of the contents associated with all of the content reproduction-permitted registrants including the present user, are displayed in the form of a list.

At step S220, it is determined whether or not to permit another registrant to reproduce a certain content recorded by the user himself/herself. If “YES” at step S220, the process branches to step S221. At step S221, the registrant ID of the another registrant is added to the content reproduction-permitted registrant ID associated with the content, and this updated information is stored in the nonvolatile storage section 112. If “NO” at step S220, the process branches to step S225.

At step S222, an initial value is assigned to the content reproduction history information associated with the content and the added content reproduction-permitted registrant ID, and this information is stored in the nonvolatile storage section 112.

At step S223, the amount of the content is divided by the number of content reproduction-permitted registrants. Then, at step S224, the equally-divided amount of the content is assigned to the registrant use capacity of the registrants set as the content reproduction-permitted registrants, and this information is stored in the nonvolatile storage section 112.

At step S225, it is determined whether or not the user abandons the permission to reproduce a certain content. If “YES” at step S225, the process branches to step S226. At step S226, the user deletes his/her own user ID from the content reproduction-permitted registrant IDs associated with the certain content, and this updated information is stored in the nonvolatile storage section 112. Then, the process proceeds to step S227 of FIG. 6. If “NO” at step S225, the process returns to step S203, and the device enters the user authentication queue state.

At step S227 of FIG. 6, the content reproduction history information associated with the content and the user is deleted.

At step S228, the amount of the content is divided by the number of content reproduction-permitted registrants. Then, at step S229, the equally-divided amount of the content is assigned to the registrant use capacity of the registrants set as the content reproduction-permitted registrants, and this information is stored in the nonvolatile storage section 112. Then, the process returns to step S203, and the device enters the user authentication queue state.

FIG. 7 is a flowchart showing the reproduction mode processing operation. In FIG. 7, at step S230, a reproduction start point of a content to be reproduced is stored in the storage section 111, and at step S231, the reproduction processing is performed.

Then at step S232, it is determined whether or not a reproduction termination factor, such as a key entry, a remote control entry, or the like, has occurred. If “YES” at step S232, the process branches to step S233, and the recording is terminated. If “NO” at step S232, the process branches to step S231, and the reproduction process is performed again.

After the termination of the reproduction, at step S234, a reproduction end point is stored in the storage section 111. At step S235, a logical sum of a region from the start point to the end point and the content reproduction history information of the present user about the present content is calculated. At step S236, the content reproduction history information of the present user about the present content is updated and stored in the nonvolatile storage section 112. Then, the process returns to step S203, and the device enters the user authentication queue state.

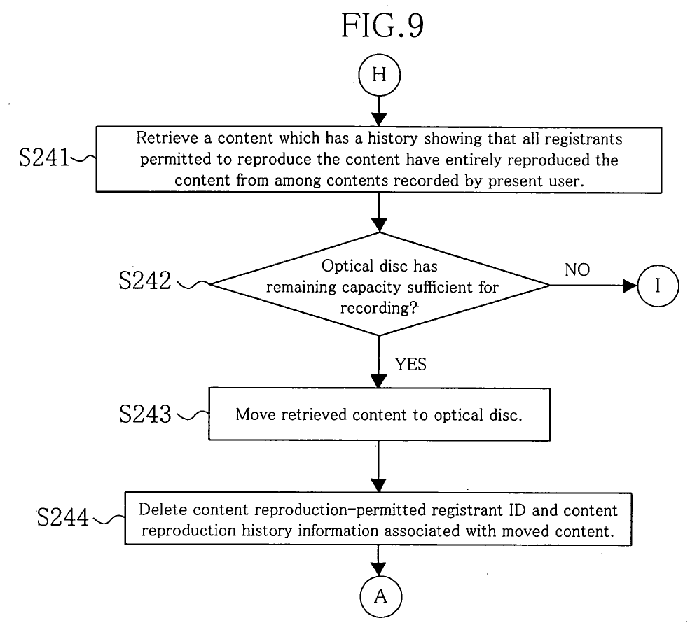

FIGS. 8 and 9 show a flowchart illustrating a process performed when the remaining capacity of the hard disk is equal to or smaller than a threshold value. In FIG. 8, at step S237, it is determined whether or not an optical disc has been inserted.

If “YES” at step S237, the process branches to step S241 of FIG. 9. If “NO” at step S237, the process branches to step S238. At step S238, a content which has a history showing that all of the registrants permitted to reproduce the content have entirely reproduced the content is retrieved from among all of the contents recorded by the present user by referring to the content reproduction history information. At step S239, the retrieved content is deleted.

At step S240, the content reproduction-permitted registrant IDs and the content reproduction history information which are associated with the deleted content are deleted. Then, the process returns to step S203, and the device enters the user authentication queue state.

At step S241, a content which has a history showing that all of the registrants permitted to reproduce the content have entirely reproduced the content is retrieved from among all of the contents recorded by the present user by referring to the content reproduction history information. At step S242, the entire amount of the retrieved content is compared with the remaining capacity of the optical disc to determine whether or not the optical disc has a remaining capacity sufficient for recording the content.

If “YES” at step S242, the process branches to step S243. At step S243, the retrieved content is moved to the optical disc. At step S244, the content reproduction-permitted registrant ID and the content reproduction history information associated with the moved content are deleted. Then, the process returns to step S203, and the device enters the user authentication queue state. If “NO” at step S242, the process branches to step S239 of FIG. 8.

As described above, according to the present invention, a reproduction-permitted registrant is set for each of the contents accumulated in a recording medium. Thus, reproduction management of the contents is realized in a more detailed manner. Because of such improved practicability, the present invention is extremely useful and possesses high industrial applicability.

1. A video recording/reproduction method, comprising the steps of:
connecting a detachable storage medium which stores a user ID indicative of a user who uses a video recording/reproduction device for recording/reproducing video data and user authentication information used for authenticating the user to the video recording/reproduction device;
collating the user ID with a registrant ID indicative of a registrant who is registered in advance in the video recording/reproduction device and permitted to use the video recording/reproduction device and collating the user authentication information with registrant authentication information which is registered in advance in the video recording/reproduction device and used for authenticating the registrant;
if the user ID matches the registrant ID and the user authentication information matches the registrant authentication information at the collation step, permitting the user to use the video recording/reproduction device; and
if a result of the collation indicates no match, prohibiting the user to use the video recording/reproduction device.

2. The video recording/reproduction method of claim 1, further comprising the steps of:
setting the user ID as a content reproduction-permitted registrant ID indicative of a registrant who is permitted to reproduce the content in association with a content recorded by the user;
selecting the content the user is permitted to reproduce;
displaying a reproducible content list including at least a recording date, content name and recording mode which are associated with the content;
selecting the content recorded by the user from the displayed reproducible content list;
setting another registrant as a content reproduction-permitted registrant of the selected content; and
deleting the user ID from among the content reproduction-permitted registrant IDs associated with the content the user is permitted to reproduce.

3. The video recording/reproduction method of claim 2, further comprising the steps of:
equally dividing the amount of the content by the number of the content reproduction-permitted registrants; and
assigning the equally-divided content amount to a registrant use capacity indicative of the capacity of a recording medium the registrant who is set as the content reproduction-permitted registrant can use.

4. The video recording/reproduction method of claim 3, further comprising the steps of:
setting content reproduction history information that shows which part of a region storing the content has been reproduced by the content reproduction-permitted registrant; and
displaying the content reproduction history information such that the content reproduction history information is included in the reproducible content list.

5. The video recording/reproduction method of claim 4, further comprising the steps of:
if the remaining capacity of the recording medium is equal to or smaller than a threshold value, extracting a content which has already been reproduced by all of the content reproduction-permitted registrants from the content reproduction history information; and
deleting the extracted content.

6. The video recording/reproduction method of claim 5, further comprising the steps of:
if the remaining capacity of the recording medium is equal to or smaller than a threshold value, extracting a content which has already been reproduced by all of the content reproduction-permitted registrants from the content reproduction history information; and
moving the extracted content to another recording medium.
